(19) United States
(12) Patent Application Publication
(10) Pub. No.: US 2026/0016999 A1
(43) Pub. Date: Jan. 15, 2026

(54) PRINTER MANAGEMENT SYSTEM AND PRINTER MANAGEMENT METHOD

(71) Applicant: Roger Wei, Pasadena, CA (US)

(72) Inventor: Roger Wei, Pasadena, CA (US)

(21) Appl. No.: 19/267,794

(22) Filed: Jul. 14, 2025

Related U.S. Application Data
(60) Provisional application No. 63/671,698, filed on Jul. 15, 2024.

(51) Int. Cl. G06F 3/12

(52) U.S. Cl. CPC G06F 3/121; G06F 3/1235; G06F 3/1239; G06F 3/1288

(57) ABSTRACT

A printer management system includes: a data collection component, connected to a plurality of printers and configured to obtain printer consumable supply data from the plurality of printers and to provide the printer consumable supply data to a database; the database, configured to analyze the printer consumable supply data to issue a low supply alert to a user terminal in response to the printer consumable supply data satisfying an alert condition; the user terminal, configured to display the low supply alert to a user.

### TECHNICAL FIELD

Embodiments of the present disclosure relate to the technical field of printer management, and more specifically, to a printer management system and a printer management system.

### BACKGROUND

Managed Print Services (MPS) is a business model in the printer service industry by which providers proactively manage business printers, via monitoring software, for a set fee under contract. Under such a service plan, printer management components such as hardware, break-fix labor, parts, supplies, and support are covered under contract, and fees are billed on a per-page basis known as a cost-per-print (CPP). However, various end-users provide feedback suggesting that the above MPS does not work ideally.

To deliver the MPS in the art, providers must buy third party software and hire high-paid analysts, salespeople, and support reps, who may not fully understand the concept themselves. Involvement of the various people in the process results in less integrity, such that toner shipments may be missed, poor maintenance may be provided for the printers, and end-users may be unsatisfied. To add to customer frustrations, the MPS model adopted by the industry lacks consistency in definition and the ability to audit is nonexistent. Therefore, the MPS in the art may be a poorly implemented offering that fails to address unique problems of each customer, and therefore, it is desirable to have improvements in printer management.

### SUMMARY

In a first aspect, the present disclosure provides a printer management system, including: a data collection component, connected to a plurality of printers and configured to obtain printer consumable supply data from the plurality of printers and to provide the printer consumable supply data to a database; the database, configured to analyze the printer consumable supply data to issue a low supply alert to a user terminal in response to the printer consumable supply data satisfying an alert condition; the user terminal, configured to display the low supply alert to a user.

In a second aspect, the present disclosure provides a printer management method, performed by the printer management system in the first aspect, the method includes: obtaining, by a data collection component, printer consumable supply data from a plurality of printers and providing the printer consumable supply data to a database; analyzing, by the database, the printer consumable supply data to issue a low supply alert to a user terminal in response to the printer consumable supply data satisfying an alert condition; displaying, by the user terminal, the low supply alert to a user.

### BRIEF DESCRIPTION OF THE DRAWINGS

FIG. 1 shows a system diagram in accordance with embodiments of the present invention.

FIG. 2 is an exemplary user interface in accordance with embodiments of the present invention.

FIG. 3 is an exemplary user interface in accordance with embodiments of the present invention.

FIG. 4 is an exemplary user interface in accordance with embodiments of the present invention.

FIG. 5 is a flowchart of a printer management method according to another embodiments of the present invention.

FIG. 6 is a flowchart of a printer management method according to another embodiments of the present invention.

### DETAILED DESCRIPTIONS

In order to make the purposes, technical solutions and advantages of the present disclosure clearer, embodiments of the present disclosure may be described in further detail by referring to the accompanying drawings.

Disclosed embodiments greatly simplify the daunting task of printer management. Embodiments may utilize a Software-as-a-Service (SaaS) model, to provide improved printer management, resulting in reduced downtime and reduced operational costs, thereby saving organizations considerable time and money.

Rather than apply a cookie-cutter solution to all businesses as traditional vendors do, disclosed embodiments provide a platform for businesses to manage their printers and meet their own unique objectives at their own pace. Businesses can use it to manage their printers more efficiently on their own, or use it in tandem with existing providers to keep track of contract terms, validate coverage, audit billing and security protocols, track service ticketing, and update and maintain their overall printer configurations.

Billing accuracy is always an issue for customers as they are confused with the language and parameters around which they are to be billed. Embodiments allow the customer to input their contract and billing information so that it can be audited for accuracy. Customers may be notified prior to contract termination and provided valuable information so they can determine the best course of action, whether that be to cancel, extend, or engage in a new agreement with a different provider.

Toner coverage is the amount of ink/toner laid out on the page. Typically, 5% is the assumed coverage per printed document. Toner coverage is reported in multiple methods. The most common method for determining coverage is based on a calculated value. This process takes the volume between cartridge replacements and compares it to the page consumption and cartridge yield. The other method is the device calculating the coverage over the life of the machine in the field. Both of these methods are highly inaccurate. With disclosed embodiments, algorithms are used to determine the actual coverage per color, per device, with several key benefits to the customer. With actual coverage, the accuracy of auto toner fulfillment increases, assessments and proposals may be more accurate, the true yield of a cartridge can be determined, and accurate cost can be assigned to a user or department.

Strategic APIs (application programming interface-which are protocols for building and integrating application software) may be set up with distributors for product and pricing for hardware and supplies, as well as with service providers platforms to integrate service ticketing into a customer's own ERP system. A customer can create a ticket within their own service portal and it may be routed and a workflow created seamlessly. This speeds up ticket resolution time, drastically reduces helpdesk support requirements/costs and also gives back more time to customers.

By use of the data collection software, devices are able to be audited for security vulnerabilities. Protocols, passwords, and other potentially vulnerable settings can be reviewed with the device settings and presented to the customer. Modern printers are similar to computers and therefore security is a top priority. Firmware is one of the things that may be evaluated and a notification may be sent to the customer regarding the current version as well as an option to push it out to outdated devices. The system may also allow for administrator passwords to be stored and encrypted and provide the ability to download configuration files for rolling out new devices.

Whatever the scenario may be, the result is that the software and the data typically collected by the service providers that use them, is controlled by actual end-users, ultimately allowing them to create a scalable and customizable solution for an improved print management experience unlike any other service available on the market today.

Disclosed embodiments provide a web-based print management software designed specifically for end-users who deal with devices that output paper in their organization. Its goal is to alleviate the most burdensome aspects of printer administration. Embodiments can automatically notify when printers need service and supplies, as well as keep notes of location and specifics about the users of each printing device in their enterprise. Disclosed embodiments offer more convenience and accuracy than the unwieldy spreadsheet that most companies currently rely on to keep track of their devices. Throughout this disclosure, the term ‘printer’ is used to cover any electronic device that consumes ink and/or toner, and outputs paper, and thus may include copiers, fax machines, and combination devices that provide print, copy, and/or fax functionality.

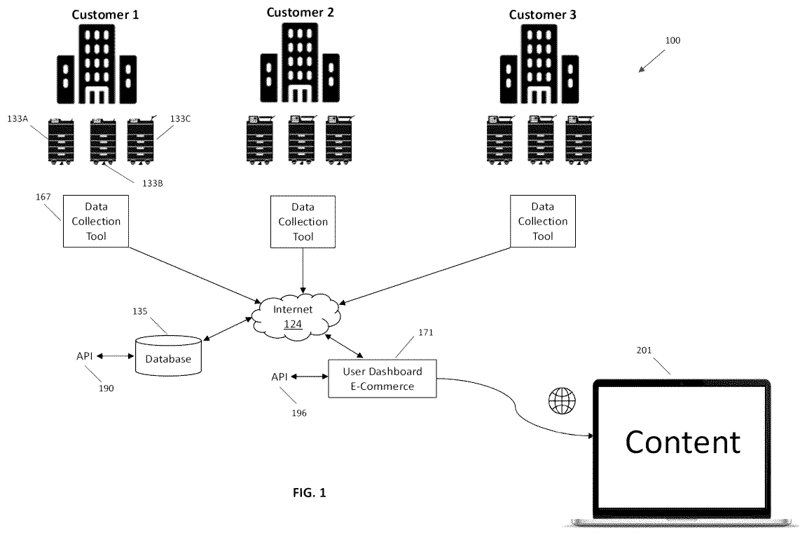

FIG. 1 shows a diagram of a system 100 in accordance with embodiments of the present invention. System 100 includes a data collection component 167. The data collection component 167 may include a computer or a server that interacts with a plurality of printers 133A, 133B, and 133C via a Simple Network Management Protocol (SNMP) port 161. Management Information Base (MIB) data may be collected, such as meter information (page counts), toner/ink levels (including low supply alerts, error messaging and other pertinent printer information, referred to as ‘printer consumable data’. Each customer may have their own data collection component and may only have access to their data on a portal or a web-interface. For example, the data collection component may be developed by the customer themselves, or may any third-party data collection component that is available in the art. The present disclosure does not limit configuration of the data collection component. The data collection component sends encrypted data externally via the internet 124 and protocol 443 (HTTPS) securely to a database 135. The database 135 stores all of the device details and analyzes the collected data. For example, the database performs algorithms to determine whether the collected data mean that any one of the plurality of printers is having a low supply. When any printer is having a low supply, the database may provide relevant notification to the customer, such as issuing low supply alerts, supply recommendations, device replacement recommendations and so on. There are APIs 190 setup with distributors that provide model specific details as well as pricing for supplies and hardware. A user dashboard and ordering e-commerce platform 171 is presented to the customer with their specific data and visible via the internet 124 on a desktop or mobile application as illustrated in 201. There may also be APIs 196 tied to the user dashboard 171 which may include an ecommerce shopping platform and a dealer login portal that can allow dealers to provide hardware or servicing capabilities on behalf of the invention.

A client device 201 interfaces to the user dashboard/e-commerce platform 171 via the internet 124. The client device 201 may be a user terminal, such as a computer, a mobile terminal, or any computing device, and so on. One client device may be arranged and connected to the plurality of printers for integral management. The dashboard 171 interfaces with an account database 135 to maintain customer accounts, inventory levels, contract/lease information, warranty information, and the like. The database 135 interfaces with data collection component 167 via protocol 443 (HTTPS) over the internet 124. The data collection component 167 may include one or more computers that interact with printers 133A, 133B, and 133C via network 124. In particular, the data collection component 167 may utilize a management protocol such as the SNMP, to query the MIB information from each printer. While three printers are shown in FIG. 1, in practice, there can be many thousands of printers monitored in embodiments of the present invention. These printers can reside at one physical location on the same network or can reside at various locations on separate networks. In order to achieve broad management of printers, in some cases, the plurality of printers may be located across various nations. The data can be merged and displayed as one account, but can only be visible to the customer whose data it is.

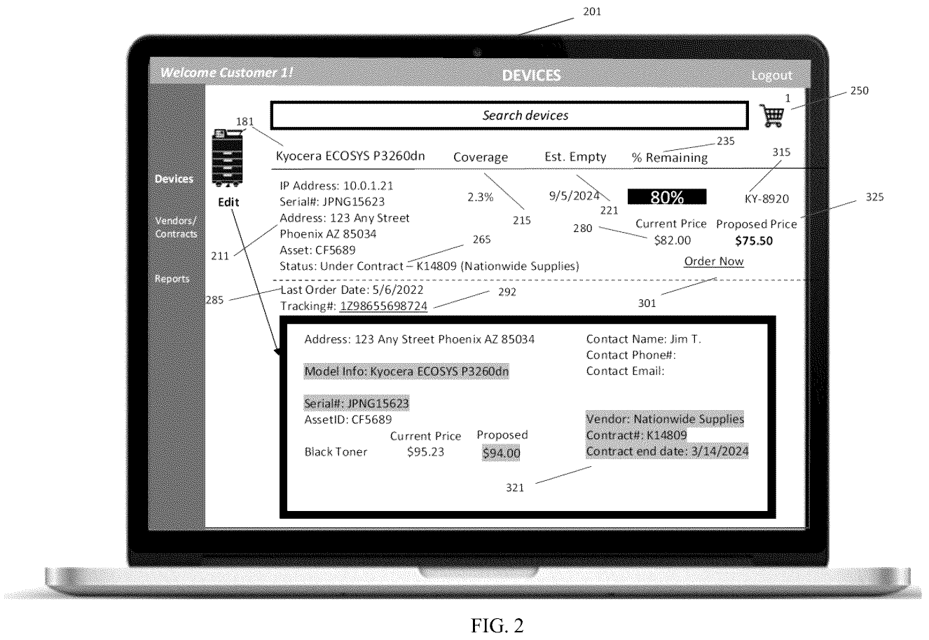

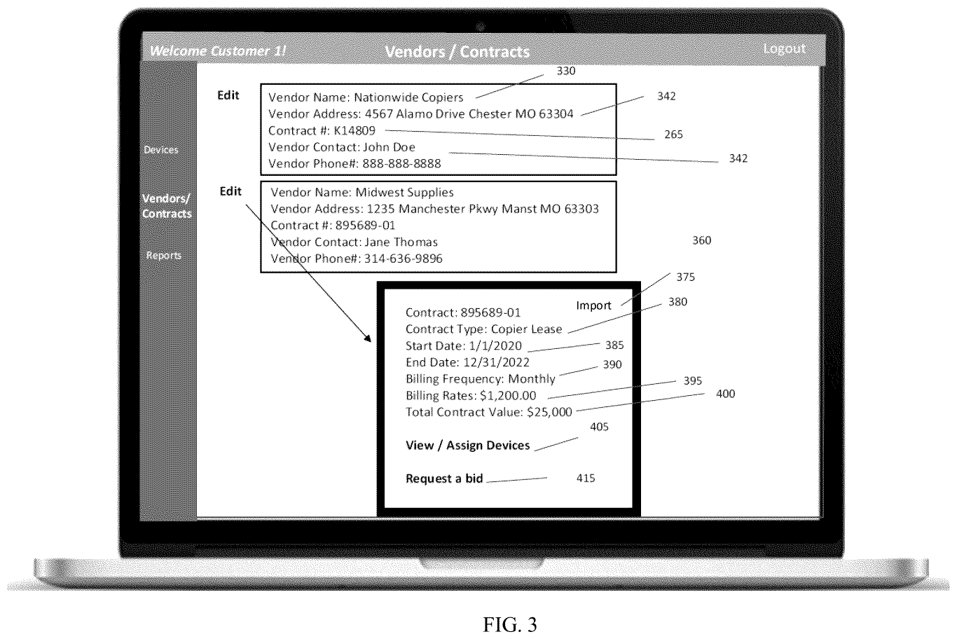

FIG. 2 is an illustration of client device 201 which may include a smartphone, tablet computer, laptop computer, desktop computer, wearable computer, or other suitable computing platform. An application (app) executing on the client device may provide various information and options for a user. The various information may include a manufacturer and a model name 181 and an address of that the device resides at for shipping purposes 211. A toner coverage 215, or the amount of toner laid on the page is shown and used for making the estimated empty date 221 of the supply more accurate. The estimated empty date is calculated based on the percentage of remaining supply, the yield of the supply, and the daily average of the supply printed in both monochrome and color. The daily average of the used supply may be determined based on the data collected by the data collection component for a certain number of days (such as 10 days, 20 days, 30 days, and so on) before a current data collection. The “supply” may include paper, black ink, color ink, and so on. A percentage (%) remaining 235 shows the percentage remaining of the supply before it runs out. The actual supply part number 315 is determined by algorithms that run in the database 135 and determine the appropriate part number based on the model of the machine 181 and the best price available from distributors that are fed to the database 135 via API connections 190. The current supply pricing is shown 280 as well as the proposed pricing 325. The current supply pricing 280 is input by the customer manually or can be imported 375 across the fleet as described in FIG. 3. The proposed pricing is the lowest priced option for the supply type 315. The contract status of the machine 265 displays the name of the vendor and the contract number. More details of the overall fleet contract and device contract editing can be found in FIG. 3. If the supply had a previous notification or was previously ordered, the date is shown 285 followed by the hyperlink for the notification or the tracking 292. A customer can click on “Order Now’ 301 to add the supply to the shopping cart 250 to then purchase the supply. The contract end date 321 may trigger a notification to the user in advance of the contract termination so the customer can elect to opt out of the contract, renew it, or bid the contract out.

FIG. 3 demonstrates how a customer can input the vendors and contracts they have for their output devices. One unified platform makes managing vendors and contracts much more manageable and allows the system the ability to provide feedback and suggestions on how to right size their environment for efficiency and savings. Vendor and contract related information can be manually entered or imported 375 into the system. The vendor name 330, address 342, the contract number 265, and vendor contact name 342 and phone number can all be added. The contract type 380 could be but not limited to a hardware lease, supplies only contract, or an all-inclusive managed print contract (hardware and supplies). The contract start and end date 385, the billing frequency 390 which could be but not limited to, monthly, quarterly, bi-annual, or annual. The billing rate 395 is based on the aforementioned frequency and the total contract value 400 is the total of the billing rate until the end of the contract term. Beyond just the overall contract terms, a customer can view or assign devices to the contract 405 and can have multiple contracts for their fleet of devices. A customer can request a bid 415 in which the system or interface may evaluate their current contract, request requirements for a new contract, and either provide the pricing or negotiate on behalf of the customer with hand selected dealers to garner a proposal. The customer can also choose to put this new bid out by themselves. The web interface can offer insight on the requirements and recommendations on what to include or not include in the RFQ (request for quote). As part of the requirements, the customer can identify if they want to utilize financing or leasing within the agreement which can be estimated as part of the process. If the invention owner takes on the contract or subcontracts the work out to another hand selected dealer, the invention owner may be responsible for the contract and supplies. The subcontractor may be responsible for servicing the devices on behalf of said owner.

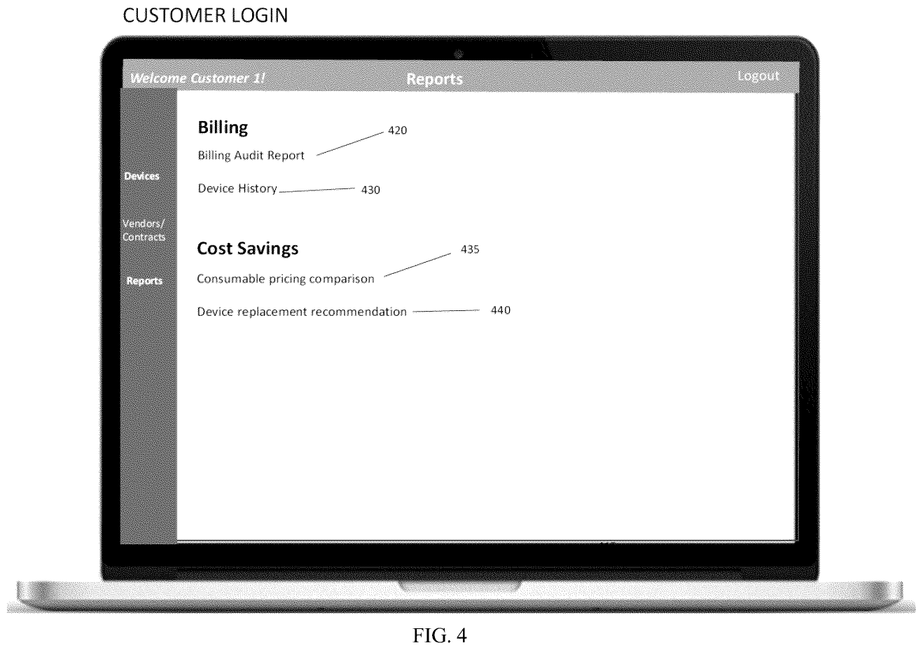

FIG. 4 details the reporting capabilities of the platform which are made visible to the customer. The billing audit report 420 shows the accuracy of the billing by the vendor to the customer. The customer must provide the vendor and contract related information such as but not limited to contract number 375, a contract type 380, a start and end date 385, a billing frequency 390, a billing rate 395. The system may use the data collection agent 167 and algorithms within the database 135 to determine if the customer is being billed accurately based on meter usage or other methods. Based on the billing frequency 390, the customer can receive an email with the billing details and can also request the details or meters be pushed to the dealer on their behalf. If the customer has multiple locations, the emailed billing details can be consolidated before being sent to the customer or the dealer into one report.

The device history report 430, shows the historical meters for each device for a certain period of time, such as up to but not limited to one year, or any time duration set in practice. This includes the monochrome, color, total, and A3 11×17 page usage. This report also shows the historical supply percentages and error messaging to validate any discrepancies a customer may encounter with their current provider or missed supply/service notifications.

Within FIG. 2 in the device section the platform displays a customer's current price 280 for a supply and the systems proposed price 325. Within the reports, the consumable pricing comparison report 435, shows the same thing except across the entire fleet, instead of just one device. Printable may use APIs 190 from multiple distribution partners to garner the best supply pricing available and store it in the master database 135 so it can then display the pricing comparison in this report. The model associated to each device references said database 135. The intent of sourcing pricing from multiple providers is to provide better pricing then what the customers' existing contract or dealer provides them.

The device replacement recommendation report 440 uses similar logic to that of the consumable pricing comparison report 435, in that it collects hardware pricing from different distribution partners via the API connection 190 and stores this in the master database 135. It then ties the model of the device 181 to that database 135 to show the best priced device replacement that meets the appropriate requirements. This recommendation may not be limited to a 1:1 replacement, meaning exact same model, but a model that is selected by the system that meets the specifications and is the best priced option for the customer. If the customer purchases the device from the platform, they would be expected to place the device on the network immediately so that it is visible to the data collection agent 167. If the device is not seen on the device agent 167 within a specified period of time, the customer may see a notification on the portal to add it.

To be noted that, services that can be integrated into the printer management system of the present disclosure are not limited to the above listed services. A customer may add other services into the printer management system. For example, a document management software, a cost control software, or any other service, which may be may be developed by a third party or may be any service available in the art.

For example, a device replacement recommendation service may be integrated in the printer management system. The device replacement recommendation service is configured to provide device replacement recommendations based on gathered data, enabling the user to order a new device through the printer management system.

In another example, a lease transaction service may be integrated. The lease transaction service may provide financing options and approvals for the user and may enable any third-party service provider to provide maintenance contracts to their customer through the lease transaction service of the printer management system.

Furthermore, the printer management system may provide Printable APIs to enable service providers to gain access to terminal devices, for bid purposes, integration of provider systems, and so on.

Furthermore, the printer management system may provide Printable APIs the user to enable integration with systems of the user their own for resource planning or internal services, and so on.

Furthermore, the printer management system may be integrated with AI to assist the user in decision making. For example, the printer management system with the AI may provide suggestions in reducing costs and identifying inefficiencies in usage across a company. The AI may be integrated into the entire printer management system, or may be integrated into certain one or more services configured in the printer management system. The AI assistant within the Printable platform will serve as an agent to answer questions typically reserved for human customer service, technical support, or sales representatives in a traditional service provider.

Questions such as, but not limited to, usage analysis, billing, contracts, equipment functionality, and technical troubleshooting can be asked directly to the AI by the end user.

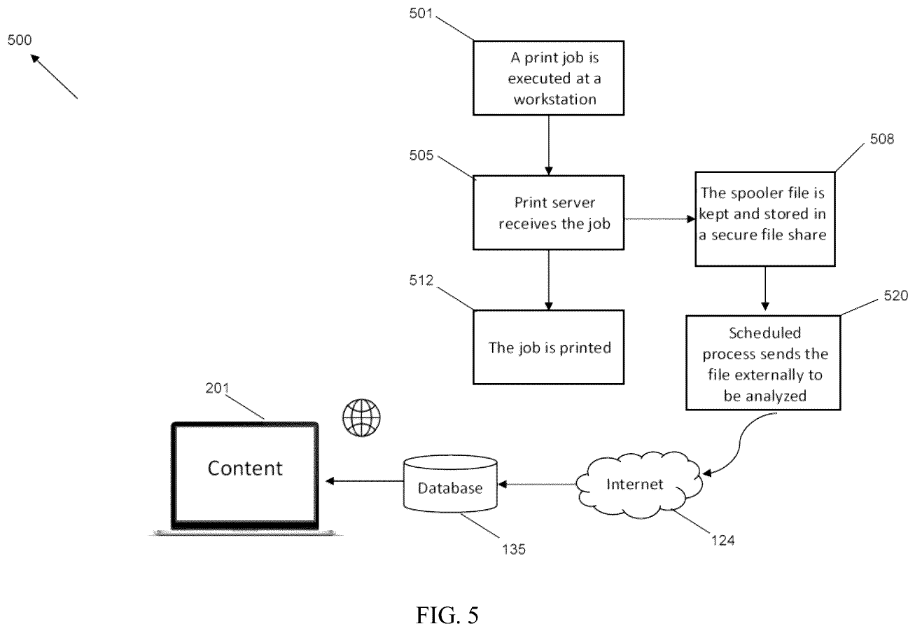

FIG. 5 is a flowchart 500 for embodiments of the present invention. At 501, a print job is executed by a user from their workstation. The print job is sent from the workstation and received by the print server 505. The print job is subsequently printed at the printer 512 while simultaneously a spooler file is kept and stored in a secure file share on the print server 508. A scheduled process sends the file externally to be analyzed 520. The file is sent to the master database 135 via HTTPS port 443 protocol over the internet 124. The coverage is then displayed within the user interface on the portal 201 in the device section. As previously noted, the coverage is used for determining the accurate days remaining on the supply, the true yield of the supply, and for proposals.

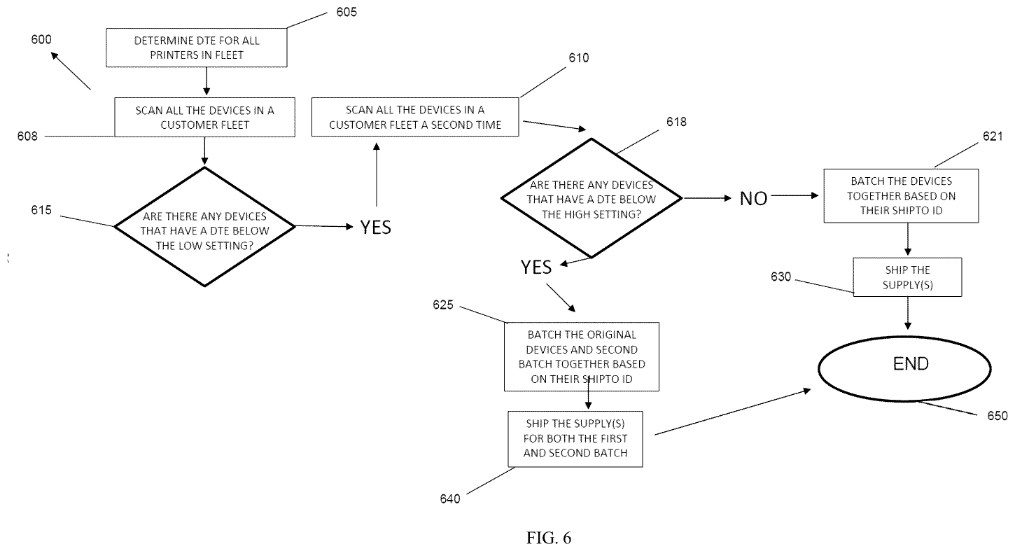

FIG. 6 is a flowchart 600 for embodiments of the present invention. In the present embodiment, a printer management method may be performed by the printer management system as described in the above and includes: obtaining, by a data collection component, printer consumable supply data from a plurality of printers and providing the printer consumable supply data to a database; analyzing, by the database, the printer consumable supply data to issue a low supply alert to a user terminal in response to the printer consumable supply data satisfying an alert condition; and displaying, by the user terminal, the low supply alert to a user

In detail, the data collection component 167 collects data from devices (i.e., 133A, 133C, and 133B in FIG. 1), and the collected data may include the MIB data as described in the above, such as meter information (page counts), toner/ink levels (including low supply alerts, error messaging and other pertinent printer information, referred to as ‘printer consumable data’. The supply may include ink, toner, and/or other consumable items for the printer. The data collection component 167 sends the data from the devices to the database 135 via the internet 124. Within the database 135, the system determines a days-till-empty (DTE), which is the number of days until the supply (such as the toner or the ink) runs out in the printer. The DTE is calculated for each individual device and by algorithms based on the current supply level, the yield of the supply, and the average pages printed per day. If the device does not provide a supply level, a warning or a message on an error screen may be evaluated for low supplies. At 605, the DTE may be calculated for each device and each supply type. The DTE calculation may vary daily based on the printer page consumption and daily pages printed average. That is, every time when the data collection component 167 collects latest data from each device, the DTE may be updated based on the latest collected data. Therefore, the DTE is always calculated based on the most actual data, instead of based on any random estimation or any unrelated or excessively old data.

At 608, the system may do a first scan of all the devices within a customer environment of all supplies. At 615, the system may determine if there any device that has any supply below a lower DTE threshold or a warning of low supplies. When at least one device is determined as having the supply below the lower DTE threshold, the user terminal may be provided with an alert and show the alert to the user, indicating that the supply for the at least one device is extremely low, and an immediate shipping of a new supply must be made. Printer scanning may but is not limited to be run for at least one time daily. For example, the printers may be scanned once or twice daily. In the case that at least one device supply is below the lower DTE threshold, all devices at the customer environment may be scanned for a second time, at 610. An exact value for the lower DTE threshold may be determined by customers in practice. For example, the lower DTE may be 1, 2, 3, 5 (days), and so on.

At 618, the system may determine if any device supply falls below a higher DTE threshold. If at least one device supply falls below the higher DTE threshold, the user terminal may be provided with an alert and show the alert to the user, indicating that the supply for the at least one device is relatively low and the device may run for a certain period time, and a shipping of a new supply needs to be prepared as soon as possible. An exact value for the higher DTE threshold may be determined by customers in practice. For example, the higher DTE may be 7, 8, 9, 12 (days), and so on. The device having the supply below the lower DTE threshold and the device having the supply below the higher DTE threshold may be batched together based on their “shipto” ID at 625. Each device has a unique address and is assigned with a “shipto” ID with the database 135. If the “shipto” ID matches for multiple supply types, the supply items may be added to one order and shipped, at 640. The ordering is comprised of communication between the database 135 and the e-commerce system 171. Devices may have different shipto IDs, as the devices may reside at various locations for a customer. If there are no additional devices that is below the higher DTE threshold, then the device having the supply below the lower DTE threshold may be batched together, at 621. The supplies are then shipped to the customer address, at 630.

As can now be appreciated disclosed embodiments improve the technical field of printer operation. Printers operate more efficiently with reduced downtime using embodiments of the present invention.

The above description shows only embodiments of the present disclosure and is not intended to limit the present disclosure. Any modification, equivalent substitution, improvement, and so on, made within the spirit and principles of the present disclosure shall be included in the scope of the present disclosure.

What is claimed is:

1. A printer management system, comprising:
a data collection component, connected to a plurality of printers and configured to obtain printer consumable supply data from the plurality of printers and to provide the printer consumable supply data to a database;
the database, configured to analyze the printer consumable supply data to issue a low supply alert to a user terminal in response to the printer consumable supply data satisfying an alert condition;
the user terminal, configured to display the low supply alert to a user.

2. The printer management system according to claim 1, wherein when analyzing the printer consumable supply data, the database is configured to calculate a days-till-empty (DTE) for each of the plurality printers.

3. The printer management system according to claim 2, wherein, when the printer consumable supply data of any one of the plurality of printers satisfying the alert condition, the database is configured to issue the low supply alert in regard to the any one of the plurality of printers.

4. The printer management system according to claim 3, wherein the printer consumable supply data of the any one of the plurality of printers satisfying the alert condition comprises: the DTE for the any one of the plurality of printers being less than a DTE threshold.

5. The printer management system according to claim 4, wherein the DTE threshold comprises a lower DTE threshold and a higher DTE threshold;
when the DTE for the any one of the plurality of printers being less than the lower DTE threshold, the low supply alert issued from the database is configured to alert the user that the any one of the plurality of printers needs to be provided with a supply at a highest urgent level; and
when the DTE for the any one of the plurality of printers being less than the higher DTE threshold, the low supply alert issued from the database is configured to alert the user that the any one of the plurality of printers needs to be provided with a supply at a second highest urgent level.

6. The printer management system according to claim 2, wherein the database is configured to calculate the DTE based on: a percentage of a remaining supply; a yield of a total supply; and a daily average usage of the supply.

7. The printer management system according to claim 6, wherein percentage of the remaining supply is obtained in real time; and the daily average usage of the supply is calculated based on a usage of the supply during a preset number of days before a current collection of the data collection component.

8. The printer management system according to claim 5, wherein in response to receiving the low supply alert, the user terminal is configured to generate an order for a new supply for the any one of the plurality of printers.

9. The printer management system according to claim 8, wherein, when more than one of the plurality of printers having the DTE less than the lower DTE threshold, the user terminal generates one order of supplies for the more than one of the plurality of printers, and the one order includes a shipment location for each of the more than one of the plurality of printers and a printer ID of each of the more than one of the plurality of printers.

10. The printer management system according to claim 8, wherein, when the plurality of printers comprise a first plurality of printers having the DTE less than the lower DTE threshold and a second plurality of printers having the DTE less than the higher DTE threshold, the user terminal generates one order of supplies for the first plurality of printers and the second plurality of printers, and the one order includes a shipment location for each of the first plurality of printers and the second plurality of printers and a printer ID of each of the first plurality of printers and the second plurality of printers.

11. The printer management system according to claim 6, wherein the data collection component is configured to scan the plurality of printers for at least one time per day to obtain the printer consumable supply data.

12. The printer management system according to claim 11, wherein the percentage of the remaining supply and the daily average usage of the supply that are used for calculating the DTE are updated after each scanning performed by the data collection component.

13. The printer management system according to claim 12, wherein the data collection component is configured to scan the plurality of printers for a second time when the DTE for the any one of the plurality of printers is less than the lower DTE threshold.

14. The printer management system according to claim 1, wherein the database is configured to provide a usage report to the user terminal to display usage of the supply at the plurality of printers.

15. The printer management system according to claim 1, further comprising a cloud server, wherein the cloud server comprises a user dashboard;
wherein the cloud server is configured to receive the printer consumable supply data collected by and sent from the data collection component; and
the user dashboard is configured to send analyzed data analyzed by the database to the user terminal.

17. The printer management system according to claim 17, wherein the user dashboard is configured to provide a cancellation reminder to the user terminal.

18. The according to claim 17, wherein the user dashboard is configured to provide a warranty status to the user terminal.

19. A printer management method, performed by the printer management system, the method comprising:
obtaining, by a data collection component, printer consumable supply data from a plurality of printers and providing the printer consumable supply data to a database;
analyzing, by the database, the printer consumable supply data to issue a low supply alert to a user terminal in response to the printer consumable supply data satisfying an alert condition;
displaying, by the user terminal, the low supply alert to a user.

20. The printer management method according to claim 19, wherein the analyzing the printer consumable supply data, comprises: calculating a date-to-empty (DTE) for each of the plurality printers; and
when the printer consumable supply data of any one of the plurality of printers satisfying the alert condition, the low supply alert in regard to the any one of the plurality of printers is issued.
